(19) United States
(12) Patent Application Publication
(10) Pub. No.: US 2025/0218605 A1
(43) Pub. Date: Jul. 3, 2025

(54) PLASMA FOCUS SYSTEMS AND METHODS FOR PRODUCING NEUTRONS

(71) Applicant: FUSE ENERGY TECHNOLOGIES CORP., San Leandro, CA (US)

(72) Inventor: Sing Lee, Chadstone, Victoria (AU)

(73) Assignee: FUSE ENERGY TECHNOLOGIES CORP., San Leandro, CA (US)

(21) Appl. No.: 18/850,535

(22) PCT Filed: Mar. 24, 2023
(86) PCT No.: PCT/US2023/016267

§ 371 Date: Sep. 24, 2024

Related U.S. Application Data
(60) Provisional application No. 63/323,684, filed on Mar. 25, 2022.

(51) Int. Cl. G21B 1/05; G21B 1/17; G21B 1/21; G21G 4/02; H05H 1/06

(52) U.S. Cl. CPC G21B 1/05; G21B 1/17; G21B 1/21; G21G 4/02; H05H 1/06

(57) ABSTRACT

A plasma focus system for neutron production is disclosed that includes an electrode assembly having an inner electrode extending along a pinch axis from a discharge end to a focus end, and an outer electrode surrounding the inner electrode to define a plasma channel for receiving a gas containing neutronic fusion fuel. The system also includes a power supply unit for applying a discharge driving signal to the electrodes, which causes the gas to be ionized into a plasma current sheath at the discharge end that flows along the plasma channel to reach the focus end where the sheath collapses toward the pinch axis to form a plasma pinch that generates fusion neutrons. The inner electrode has a tapered tip at the focus end that is configured to increase a speed of the sheath sufficiently to reach a pinch temperature at which the fusion neutrons are predominantly of thermonuclear origin.

### RELATED PATENT APPLICATION

The present application claims priority to U.S. Provisional Patent Application No. 63/323,684 filed on Mar. 25, 2022, the disclosure of which is incorporated herein by reference in its entirety.

### TECHNICAL FIELD

The technical field generally relates to plasma technologies and, more particularly, to plasma focus systems and methods for producing neutrons.

### BACKGROUND

Dense plasma focus systems (or simply plasma focus systems) are pinch-based plasma generation systems in which a high pulsed voltage is applied between two coaxial electrodes disposed inside a vacuum chamber filled with a process or working gas. The coaxial electrodes extend from a closed end to an open end, with an electrical insulator disposed between the electrodes at the closed end. The application of the voltage leads to the ionization and breakdown of the gas on the insulator, and the formation of a plasma shockwave-current-sheath layer, hereinafter referred to as a plasma current sheath for simplicity. Under the effect of the Lorentz force created by the radial current flowing in the plasma and the current-induced azimuthal magnetic field, the current sheath is driven axially along the electrodes toward the open end. Upon reaching the open end, the current sheath is radially compressed onto the axis to form a hot and dense pinch plasma column. During the pinch phase, plasma instabilities can lead to the emission of electron and ion beams, electromagnetic radiation pulses (e.g., X-rays), and, if the process gas contains neutronic fusion fuel, neutrons. For example, neutrons at 2.45 MeV can be generated when using deuterium as the working gas, while neutrons at 14.1 MeV can be generated when using a deuterium-tritium mixture. In fusion power applications, the kinetic energy of the fusion neutrons is converted into thermal energy, which is subsequently converted into electricity. In conventional plasma focus devices, most of the neutrons are produced from beam-target reactions, with a small or negligible fraction originating from thermonuclear reactions.

### SUMMARY

The present description generally relates to plasma focus systems and methods for producing neutrons with a neutron yield having a predominant thermonuclear component.

In accordance with an aspect, there is provided a plasma focus system for neutron production, including:
an electrode assembly including:
   an inner electrode extending along a pinch axis between a discharge end and a focus end, the inner electrode terminating in a tapered tip at the focus end; and
   an outer electrode surrounding the inner electrode and defining therebetween a plasma channel configured to receive a process gas including neutronic fusion fuel; and
a power supply unit configured to apply a discharge driving signal to the inner electrode and the outer electrode, wherein applying the discharge driving signal causes the process gas to be ionized into a plasma current sheath at the discharge end and the plasma current sheath to flow along the plasma channel and reach the focus end where the plasma current sheath collapses toward the pinch axis to form a plasma pinch from which fusion neutrons are generated with a neutron yield having a beam-target yield component and a thermonuclear yield component, and wherein the tapered tip is configured to increase a speed of the plasma current sheath flowing therealong sufficiently for the plasma pinch to reach a pinch temperature at which the thermonuclear yield component exceeds the beam-target yield component.

In some embodiments, the tapered tip tapers from a first radius, at a taper start point located between the discharge end and the focus end, to a second radius, at the focus end, wherein a ratio of the first radius to the second radius is greater than eight. In some embodiments, the ratio of the first radius to the second radius ranges between from about eight to about fifty.

In some embodiments, the first radius ranges from about 1 cm to about 30 cm and the second radius ranges from about 1 mm to about 40 mm. In some embodiments, the tapered tip tapers from the first radius to the second radius at a tapering angle ranging from about 40° to about 85°, wherein the tapering angle is defined with respect to a direction parallel to the pinch axis. In some embodiments, the tapered tip tapers linearly from the first radius to the second radius. In other embodiments, the tapered tip tapers nonlinearly from the first radius to the second radius.

In some embodiments, the tapered tip has a longitudinal extent ranging from about 1 cm to about 10 cm. In some embodiments, a ratio of the longitudinal extent of the tapered tip to a longitudinal extent of the inner electrode ranges from about 0.05 to about 0.7.

In some embodiments, a ratio of a longitudinal extent of the inner electrode to a diameter of the inner electrode at the discharge end is greater than one. In other embodiments, a ratio of a longitudinal extent of the inner electrode to a diameter of the inner electrode at the discharge end is equal to or less than one.

In some embodiments, the tapered tip has a hollow interior configured to allow the plasma pinch to extend at least partially thereinside.

In some embodiments, the power supply unit includes a pulsed-DC power supply including a capacitor bank and a switch.

In some embodiments, the power supply unit is configured to apply the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.

In some embodiments, the power supply unit is configured to apply the discharge driving signal once every one minute to sixty minutes, corresponding to a single-shot operation mode. In some embodiments, the power supply unit is configured to apply the discharge driving signal once every ten milliseconds to ten seconds, corresponding to a repetitive-shot operation mode.

In some embodiments, the power supply unit is configured to apply the discharge driving signal based on the configuration of the tapered tip to control the speed of the plasma current sheath to reach a maximum sheath speed value ranging from about 60 cm/μs to about 500 cm/μs as the plasma current sheath collapses toward the pinch axis to form the plasma pinch. Such maximum sheath speed values are higher than the maximum speed values of plasma current sheaths in the radial phase of non-tapered arrangements, which can range from about 14 cm/μs to about 30 cm/μs. In some embodiments, the plasma focus system is configured to increase a maximum speed of the plasma current sheath by a speed-enhancement factor ranging from about four to about thirty compared to conventional plasma focus systems provided with non-tapered inner electrodes.

In some embodiments, the power supply unit is configured to apply the discharge driving signal based on the configuration of the tapered tip to form the plasma pinch with a pinch temperature ranging from about 3 keV to about 200 keV.

In some embodiments, the power supply unit is configured to apply the discharge driving signal to control the speed of the plasma current sheath prior to the tapered tip to remain below a threshold sheath speed value at which the plasma current sheath undergoes mass-field-force-field separation. In some embodiments, the threshold sheath speed value is about 10 cm/μs.

In some embodiments, the power supply unit is configured to apply the discharge driving signal based on the configuration of the tapered tip to control a ratio of the thermonuclear yield component to the beam-target yield component to range from about 10 to about 100,000. In some embodiments, the power supply unit is configured to apply the discharge driving signal based on the configuration of the tapered tip to control a ratio of the thermonuclear yield component to the total neutron yield to be larger than 0.6, or larger than 0.7, or larger than 0.8, or larger than 0.9, or larger than 0.95, or larger than 0.99.

In some embodiments, the electrode assembly includes an electrical insulator interposed between the inner electrode and the outer electrode at the discharge end.

In some embodiments, the plasma focus system includes a vacuum chamber housing at least part of the electrode assembly and configured to contain the process gas therein. In some embodiments, the outer electrode forms part of the vacuum chamber.

In some embodiments, the plasma focus system includes a process gas supply unit configured to supply the process gas inside the plasma channel. In some embodiments, the vacuum chamber can include at least one gas inlet port configured for connection to the process gas supply unit to allow the process gas to be introduced inside the vacuum chamber, and thus inside the plasma channel.

In some embodiments, the neutronic fusion fuel includes deuterium or a mixture of deuterium and tritium.

In some embodiments, a fill pressure of the process gas inside the plasma channel ranges from about 1 Torr to about 100 Torr.

In some embodiments, the inner electrode is configured as an anode and the outer electrode is configured as a cathode, in that the inner electrode is positively biased with respect to the outer electrode. In other embodiments, the polarity of the inner and outer electrodes is reversed.

In accordance with another aspect, there is provided a plasma focus method of neutron production, including:
providing a plasma focus system including an electrode assembly having an inner electrode extending along a pinch axis between a discharge end and a focus end and an outer electrode surrounding the inner electrode and defining therebetween a plasma channel, wherein the inner electrode terminates in a tapered tip at the focus end;
supplying a process gas including neutronic fusion fuel inside the plasma channel; and
applying a discharge driving signal to the inner electrode and the outer electrode to ionize the process gas into a plasma current sheath at the discharge end and to flow the plasma current sheath along the plasma channel until the plasma current sheath reaches the focus end and collapses toward the pinch axis to form a plasma pinch from which fusion neutrons are generated with a neutron yield having a beam-target yield component and a thermonuclear yield component,
wherein the tapered tip is configured to increase a speed of the plasma current sheath flowing therealong sufficiently for the plasma pinch to reach a pinch temperature at which the thermonuclear yield component exceeds the beam-target yield component.

In some embodiments, providing the plasma focus system includes configuring the tapered tip to taper from a first radius, at a taper start point located between the discharge end and the focus end, to a second radius, at the focus end, wherein a ratio of the first radius to the second radius ranges from about eight to about fifty. In some embodiments, the first radius ranges from about 1 cm to about 30 cm and the second radius ranges from about 1 mm to about 40 mm. In some embodiments, configuring the tapered tip includes providing the tapered tip with a tapering angle ranging from about 40° to about 85°, wherein the tapering angle is defined with respect to a direction parallel to the pinch axis.

In some embodiments, configuring the tapered tip includes providing the tapered tip with a longitudinal extent ranging from about 1 cm to about 10 cm.

In some embodiments, applying the discharge driving signal includes applying the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.

In some embodiments, applying the discharge driving signal includes applying the discharge driving signal once every one minute to sixty minutes, corresponding to a single-shot operation mode. In some embodiments, applying the discharge driving signal includes applying the discharge driving signal once every ten milliseconds to ten seconds, corresponding to a repetitive-shot operation mode.

In some embodiments, applying the discharge driving signal includes controlling the discharge driving signal based on the configuration of the tapered tip to control the speed of the plasma current sheath to reach a maximum sheath speed value ranging from about 60 cm/μs to about 500 cm/μs as the plasma current sheath collapses toward the pinch axis to form the plasma pinch.

In some embodiments, applying the discharge driving signal includes controlling the discharge driving signal based on the configuration of the tapered tip to form the plasma pinch with a pinch temperature ranging from about 3 keV to about 200 keV.

In some embodiments, applying the discharge driving signal includes controlling the discharge driving signal to control the speed of the plasma current sheath prior to the tapered tip to remain below a threshold sheath speed value at which the plasma current sheath undergoes mass-field-force-field separation. In some embodiments, the threshold sheath speed value is about 10 cm/μs.

In some embodiments, applying the discharge driving signal includes controlling the discharge driving signal based on the configuration of the tapered tip to control a ratio of the thermonuclear yield component to the beam-target yield component to range from about 10 to about 100,000. In some embodiments, applying the discharge driving signal includes controlling the discharge driving signal based on the configuration of the tapered tip to control a ratio of the thermonuclear yield component to the total neutron yield to be larger than 0.6, or larger than 0.7, or larger than 0.8, or larger than 0.9, or larger than 0.95, or larger than 0.99.

In some embodiments, providing the plasma focus system includes enclosing at least part of the electrode assembly in a vacuum chamber configured to contain the process gas therein.

In some embodiments, the neutronic fusion fuel includes deuterium or a mixture of deuterium and tritium.

In accordance with another aspect, there is provided a plasma focus system for neutron production, the plasma focus system including:
an inner electrode extending along a pinch axis between a discharge end and a focus end, the inner electrode terminating in a tapered tip at the focus end; and
an outer electrode surrounding the inner electrode and defining therebetween a plasma channel configured to receive a process gas,
wherein applying the discharge driving signal causes the process gas to be ionized into a plasma current sheath at the discharge end and the plasma current sheath to flow along the plasma channel and reach the focus end where the plasma current sheath collapses toward the pinch axis to form a plasma pinch from which neutrons are generated with a neutron yield having a beam-target yield component and a thermonuclear yield component, and wherein the tapered tip is configured to increase a speed of the plasma current sheath flowing therealong sufficiently for the plasma pinch to reach a pinch temperature at which the thermonuclear yield component exceeds the beam-target yield component.

Other method and process steps may be performed prior, during, or after the steps described herein. The order of one or more steps may also differ, and some of the steps may be omitted, repeated, and/or combined, as the case may be.

Other objects, features, and advantages of the present description will become more apparent upon reading of the following non-restrictive description of specific embodiments thereof, given by way of example only with reference to the appended drawings. Although specific features described in the above summary and in the detailed description below may be described with respect to specific embodiments or aspects, it should be noted that these specific features may be combined with one another unless stated otherwise.

### BRIEF DESCRIPTION OF THE DRAWINGS

FIG. 1 is a schematic longitudinal cross-sectional view of a plasma focus system, in accordance with an embodiment.

FIG. 2 is a schematic longitudinal cross-sectional view of a plasma focus system, in accordance with another embodiment.

FIG. 3 is a schematic longitudinal cross-sectional view of a plasma focus system, in accordance with another embodiment.

FIG. 4 is a schematic longitudinal cross-sectional view of a plasma focus system, in accordance with another embodiment.

FIG. 5 is a schematic longitudinal cross-sectional view of a plasma focus system, in accordance with another embodiment.

FIG. 6 is a schematic front elevation cross-sectional view of a plasma focus system, in accordance with another embodiment.

FIG. 7 is a schematic longitudinal cross-sectional view of a plasma focus system, in accordance with another embodiment.

FIG. 8 is a schematic longitudinal cross-sectional view of a plasma focus system, in accordance with another embodiment.

FIG. 9 is a flow diagram of a plasma focus method of neutron production, in accordance with an embodiment.

FIG. 10 depicts curves of the Maxwell-averaged thermonuclear reactivity <σv> plotted as functions of temperature T on a log-log scale for the D-T and D-D reactions, in accordance with an embodiment.

### DETAILED DESCRIPTION

In the present description, similar features in the drawings have been given similar reference numerals. To avoid cluttering certain figures, some elements may not be indicated if they were already identified in a preceding figure. The elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. Such spatially relative terms are intended to encompass different orientations in the use or operation of the present embodiments, in addition to the orientations exemplified in the figures. Furthermore, when a first element is referred to as being “on”, “above”, “below”, “over”, or “under” a second element, the first element can be either directly or indirectly on, above, below, over, or under the second element, respectively, such that one or multiple intervening elements may be disposed between the first element and the second element.

The terms “a”, “an”, and “one” are defined herein to mean “at least one”, that is, these terms do not exclude a plural number of elements, unless stated otherwise.

The term “or” is defined herein to mean “and/or”, unless stated otherwise.

The expressions “at least one of X, Y, and Z” and “one or more of X, Y, and Z”, and variants thereof, are understood to include X alone, Y alone, Z alone, any combination of X and Y, any combination of X and Z, any combination of Y and Z, and any combination of X, Y, and Z.

Terms such as “substantially”, “generally”, and “about”, which modify a value, condition, or characteristic of a feature of an exemplary embodiment, should be understood to mean that the value, condition, or characteristic is defined within tolerances that are acceptable for the proper operation of this exemplary embodiment for its intended application or that fall within an acceptable range of experimental error. In particular, the term “about” generally refers to a range of numbers that one skilled in the art would consider equivalent to the stated value (e.g., having the same or an equivalent function or result). In some instances, the term “about” means a variation of +10% of the stated value. It is noted that all numeric values used herein are assumed to be modified by the term “about”, unless stated otherwise. The term “between” as used herein to refer to a range of numbers or values defined by endpoints is intended to include both endpoints, unless stated otherwise.

The term “based on” as used herein is intended to mean “based at least in part on”, whether directly or indirectly, and to encompass both “based solely on” and “based partly on”. In particular, the term “based on” may also be understood as meaning “depending on”, “representative of”, “indicative of”, “associated with”, “relating to”, and the like.

The terms “match”, “matching”, and “matched” refer herein to a condition in which two elements are either the same or within some predetermined tolerance of each other. That is, these terms are meant to encompass not only “exactly” or “identically” matching the two elements, but also “substantially”, “approximately”, or “subjectively” matching the two elements, as well as providing a higher or best match among a plurality of matching possibilities.

The terms “connected” and “coupled”, and derivatives and variants thereof, refer herein to any connection or coupling, either direct or indirect, between two or more elements, unless stated otherwise. For example, the connection or coupling between elements may be mechanical, optical, electrical, magnetic, thermal, chemical, fluidic, logical, operational, or any combination thereof.

The term “concurrently” refers herein to two or more processes that occur during coincident or overlapping time periods. The term “concurrently” does not necessarily imply complete synchronicity and encompasses various scenarios including time-coincident or simultaneous occurrence of two processes; occurrence of a first process that both begins and ends during the duration of a second process; and occurrence of a first process that begins during the duration of a second process, but ends after the completion of the second process.

The present description generally relates to plasma focus systems and methods for producing neutrons with a predominance of thermonuclear neutrons compared to beam-target neutrons. The techniques disclosed herein may be used in various fields and applications that use neutrons, including, to name a few, fusion power applications, reactor wall testing, materials processing, and neutron spectroscopy.

Nuclear fusion energy is energy produced by a nuclear fusion process in which at least two lighter atomic nuclei are joined to form a heavier nucleus whose mass is less than the sum of the masses of the lighter nuclei. The difference in mass is released as energy, which can be harnessed to produce electricity. Fusion reactions can be neutronic or aneutronic depending on whether the fusion reaction products include neutrons or not, in addition to charged nuclei. Non-limiting examples of neutronic fusion reactions include the deuterium-deuterium (D-D) reaction and the deuterium-tritium (D-T) reaction, which generates neutrons at 2.45 MeV and 14.1 MeV, respectively.

Plasma focus systems produce fusion neutrons by two different mechanisms: beam-target fusion reactions and thermonuclear fusion reactions. Beam-target fusion neutrons are produced when a high-energy ion beam collides with a stationary ion target, whereas thermonuclear neutrons are produced by fusion reactions between ions in the high-energy tail of the thermal ion population. The basic principles governing these two neutron production mechanisms in the context of plasma focus systems are generally known in the art and need not be described in detail herein other than to facilitate an understanding of the present techniques.

It has been observed that a wide range of conventional neutron-optimized plasma focus systems operate with a speed factor (or drive parameter) S=(I/a)p^{-1/2} having a near-constant value of 89±8 kA·cm⁻¹·Torr^{-1/2}, where I is the peak drive current, a is the anode radius, and p is the fill gas pressure [1]. This near-constant value of Sis consistent with a narrow range of peak axial speeds around 10 cm/μs and peak radial speeds around 20-30 cm/μs. These speed values lead to pinch temperatures ranging from about 0.1 keV to about 1 keV. The inductive effects of these speeds generate beam ions with energies ranging from tens to hundreds of keV. At such pinch temperatures, the thermonuclear fusion cross-sections in the pinch are some 12 to 14 orders of magnitude below significant levels, which would be reached at pinch temperatures of the order of at least 10 keV. Meanwhile, at such beam ion energies, the beam-target fusion cross-sections are already at significant, if not near-optimum, values. As a result, fusion neutrons produced by conventional plasma focus systems originate predominantly, if not nearly exclusively, from beam-target reactions, with only a small, if not negligible, proportion coming from thermonuclear reactions [2]. The predominantly beam-target origin of the neutrons produced by conventional plasma focus systems can sometimes be a drawback or limitation, as having a large yield of thermonuclear neutrons can be desirable or even necessary in certain applications. This is because thermonuclear neutrons are emitted in a much more isotropic manner compared to beam-gas target neutrons, which tend to have a spatial distribution peaked along the forward direction of the ion beam. The energy spectra also differ for the two types of neutrons so that having thermonuclear neutrons increases the choice of spectra. Thermonuclear neutrons also avoid the deleterious effects associated with remnant ion beams in the production of beam-gas target neutrons.

In order to transition to a predominantly thermonuclear neutron production mode, the pinch temperature should be increased to at least about 10 keV, which represents an increase of about 50 times compared to pinch temperatures values observed in conventional plasma focus systems. As pinch temperature scales about quadratically with plasma speed, such an increase in pinch temperature could, in principle, be achieved by increasing the peak plasma speeds of conventional plasma focus systems by a factor of the order of 50^{1/2}≈7, that is, from about 10 cm/μs to about 70 cm/μs for the peak axial speed and from about 20-30 cm/μs to about 140-210 cm/μs for the peak radial speed. However, conventional plasma focus systems tend to not operate well above certain speeds. It was found that increasing the peak axial speed above 10 cm/μs can lead to a separation between the mass-field and the force-field in the magnetic field structure of the plasma. This separation causes the mass-field to reach the end of the axial acceleration phase and enter the radial collapse phase, while the driving force-field is still in the axial phase. In this situation the force-field is pushing in the axial direction while the mass-field is already flowing in the radial direction. This angular disparity between the pushing force-field and the mass-field can result in a pinch characterized by poor compression and low neutron yield.

The present techniques aim to provide plasma focus systems and methods in which the pinch temperature can be increased sufficiently for the thermonuclear yield component to exceed the beam-target yield component, but in which the angular disparity mentioned above, due to mass-field-force-field separation, can be avoided or at least mitigated. As described in greater detail below, this transition to a predominantly thermonuclear neutron production mode can be achieved at least in part by the provision of a tapered tip at the focus end of the inner electrode of the plasma focus system. In the context of the present techniques, the tapered tip can be referred to herein as a thermonuclear converter.

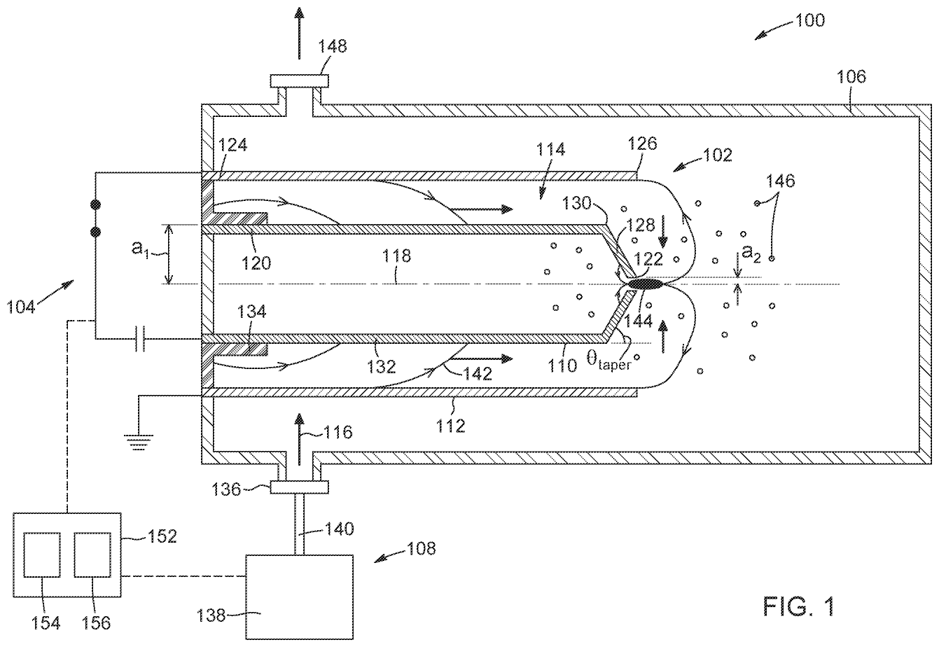

Referring to FIG. 1, there is illustrated a schematic longitudinal cross-sectional view of an embodiment of a plasma focus system 100 used for neutron production with an enhanced proportion of thermonuclear neutrons. The plasma focus system 100 of FIG. 1 generally includes an electrode assembly 102, a power supply unit 104, a vacuum chamber 106, and a process gas supply unit 108. More details regarding the structure, configuration, and operation of these components and other possible components of the plasma focus system 100 are provided below. It is appreciated that FIG. 1 is a simplified schematic representation that illustrates certain features and components of the plasma focus system 100, such that additional features and components that may be useful or necessary for its practical operation may not be specifically depicted. Non-limiting examples of such additional features and components can include, to name a few, power supplies, electrical connections, gas sources, gas supply lines (e.g., conduits, such as pipes or tubes), pressure and flow control devices (e.g., pumps, valves, regulators, restrictors), temperature control devices (e.g., chillers for electrodes), operation monitoring and diagnostic devices (e.g., sensors), processors and controllers, and other types of hardware and equipment.

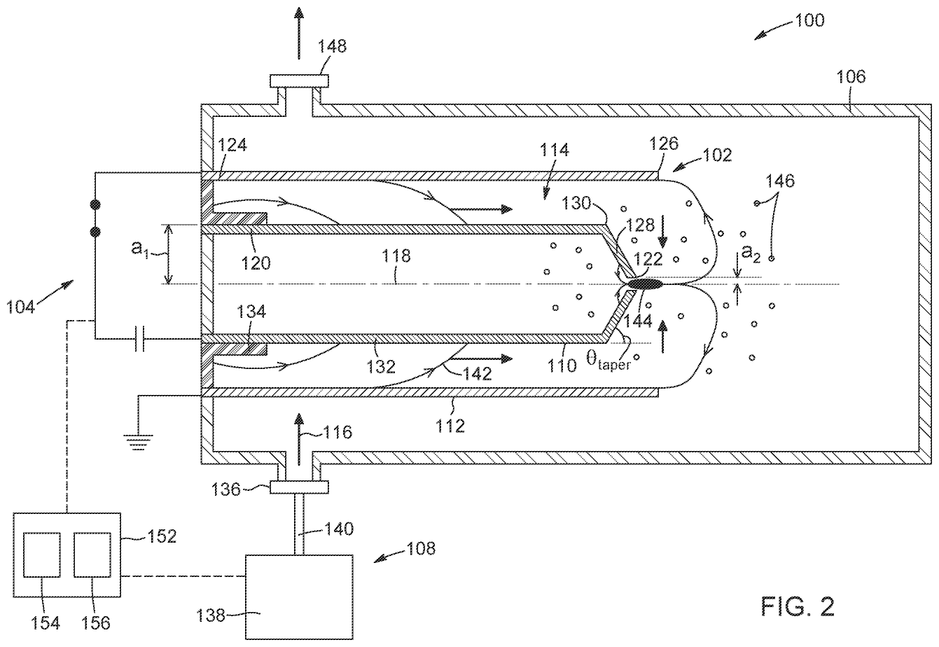

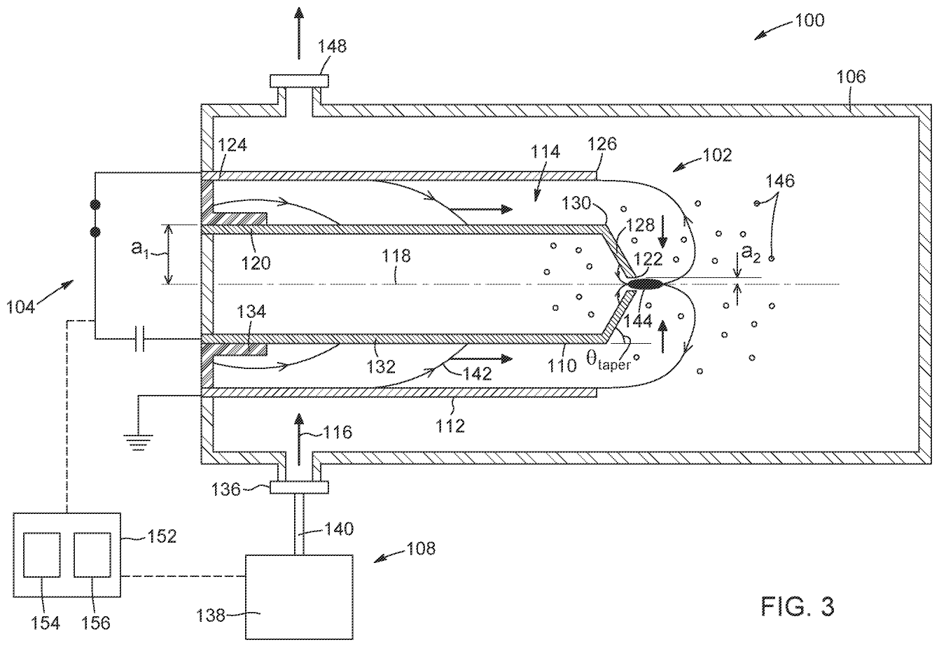

The electrode assembly 102 includes an inner electrode 110 and an outer electrode 112 forming a plasma gun. In FIG. 1, the inner electrode 110 is configured as an anode and the outer electrode 112 is configured as a cathode (i.e., the inner electrode 110 is positively biased with respect to the outer electrode 112), but reversing the polarity of the electrodes 110, 112 is possible in other embodiments. The outer electrode 112 surrounds the inner electrode 110 with an interelectrode radial gap therebetween defining an annular plasma channel 114 configured to receive therein a process gas 116 including neutronic fusion fuel. Each of the inner electrode 110 and the outer electrode 112 has an elongated configuration along a pinch axis 118. As used herein, the terms “longitudinal” and “axial” refer to a direction parallel to the pinch axis 118, while the terms “radial” and “transverse” refer to a direction that lies in a plane perpendicular to the pinch axis 118. The inner electrode 110 extends longitudinally between a discharge end 120 and a focus end 122, and the outer electrode 112 extends longitudinally between a discharge end 124 and a focus end 126. The inner electrode 110 terminates in a tapered tip 128 at the focus end 122. In some embodiments, the focus end 122 of the inner electrode 110 is longitudinally aligned with the focus end 126 of the outer electrode 112. In other embodiments, the focus end 122 of the inner electrode 110 is disposed longitudinally ahead or behind the focus end 126 of the outer electrode 112, as depicted in FIGS. 2 and 3, respectively.

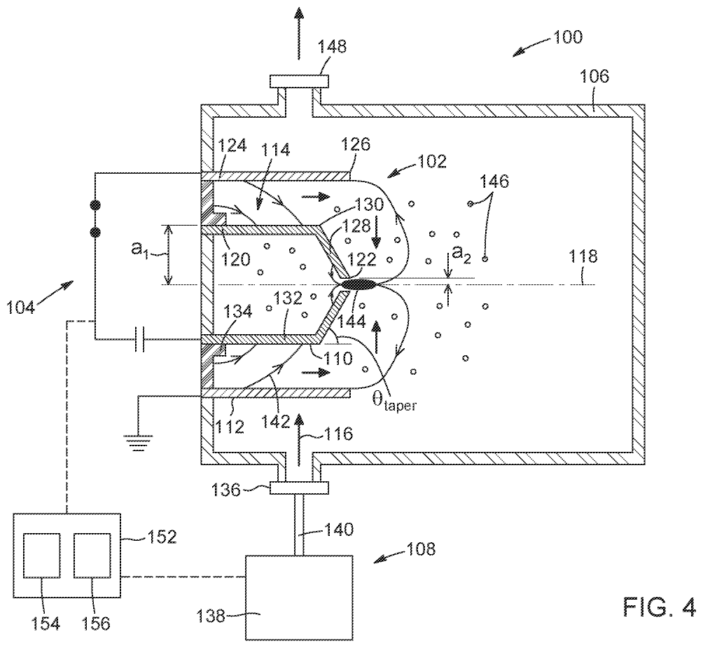

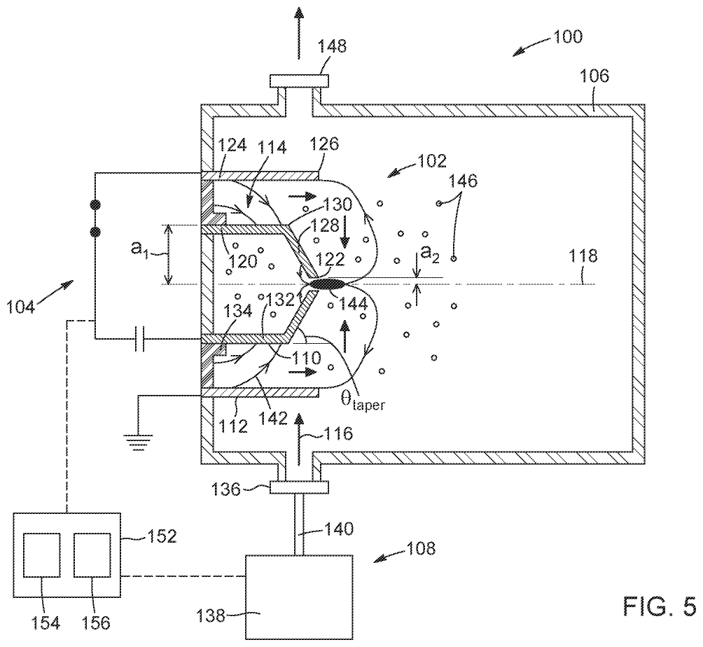

Returning to FIG. 1, in the illustrated arrangement, the inner electrode 110 and the outer electrode 112 both have a substantially cylindrical configuration, with a circular cross-section transverse to the pinch axis 118. The outer electrode 112 encloses the inner electrode 110 in a coaxial arrangement with respect to the pinch axis 118. Other electrode configurations may be used in other embodiments. Non-limiting examples include, to name a few, non-coaxial arrangements and non-circularly symmetric transverse cross-sections. In some embodiments, the inner electrode 110 may have a length ranging from about 4 cm to about 80 cm and a radius ranging from about 1 cm to about 30 cm (in the non-tapered section). In some embodiments, the outer electrode 112 may have a length ranging from about 3 cm to about 100 cm, and a radius ranging from about 2 cm to about 40 cm. Other inner and outer electrode dimensions may be used in other embodiments. Depending on the application, the ratio of the length to the diameter (outside the tapered tip 128) of the inner electrode 110 can be greater than (as depicted in FIG. 1), equal to (as depicted in FIG. 4), or less than one (as depicted in FIG. 5).

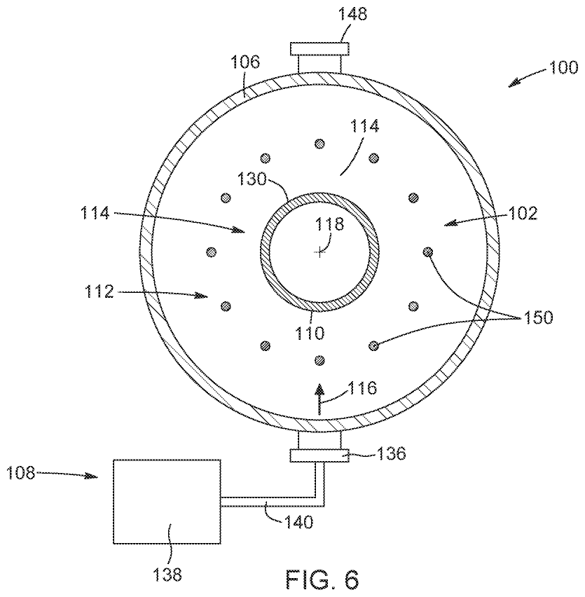

Returning to FIG. 1, the inner electrode 110 and the outer electrode 112 may each be made of any suitable electrically conductive material, such as various metals and metal alloys. Non-limiting examples include, to name a few, copper and brass. In some embodiments, the outer electrode 112 may have a hollow cylindrical body with a continuous circumferential surface. Referring to FIG. 6, in other embodiments, the outer electrode 112 may include a set of rods 150 extending longitudinally along and distributed azimuthally around the pinch axis 118, so that the outer electrode 112 has a discontinuous circumferential surface, with inter-rod gaps formed by the azimuthal spaces between the rods 150.

Returning to FIG. 1, the plasma channel 114 has a substantially annular cross-sectional shape defined by the cross-sectional shapes of the inner electrode 110 and the outer electrode 112. The plasma channel 114 has a closed end, at the discharge ends 120, 124 of the electrodes 110, 112, and an open end, at the focus ends 122, 126 of the electrodes 110, 112. As the plasma channel 114 forms a portion of the interior of the vacuum chamber 106, the plasma channel 114 is configured to receive the process gas 116 from the process gas supply unit 108.

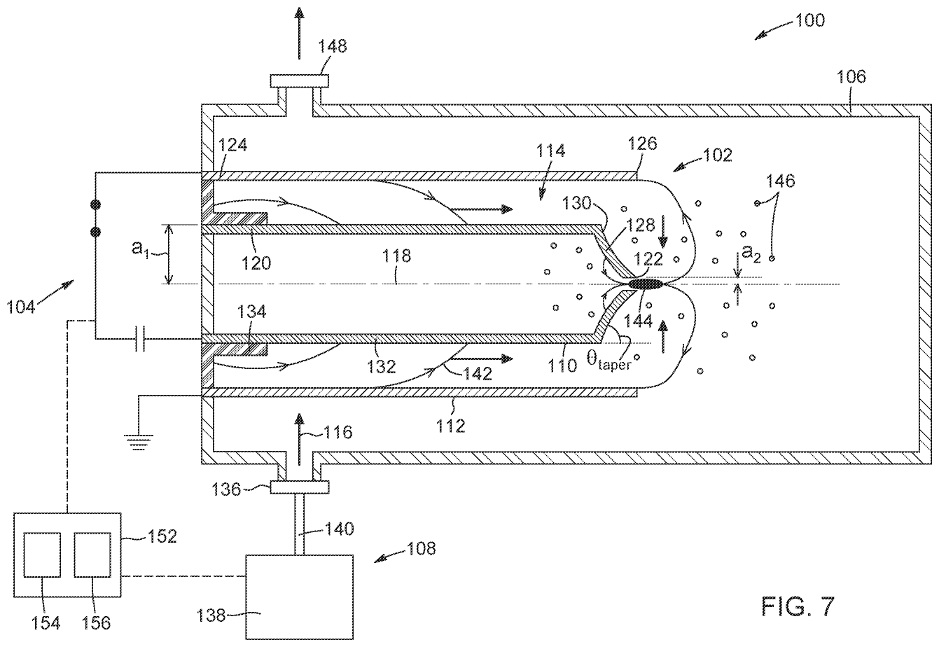

Referring still to FIG. 1, the tapered tip 128 tapers from a first radius a₁, at a taper start point 130 located between the discharge end 120 and the focus end 122 to a second radius a₂, at the focus end 122. The straight section 132 of the inner electrode 110 that extends between the discharge end 120 and the taper start point 130 has a longitudinally constant transverse cross-section of radius a₁. In some embodiments, the radius ratio a₁/a₂ ranges from about eight to about fifty. For example, the radius ratio a₁/a₂ may be larger than eight (e.g., between eight and fifty), or larger than ten (e.g., between ten and fifty), or larger than twelve (e.g., between twelve and fifty), or larger than fifteen (e.g., between fifteen and fifty), or larger than twenty (e.g., between twenty and fifty), or larger thirty (e.g., between thirty and fifty), or larger than forty (e.g., between forty and fifty). In some embodiments, the first radius a₁ ranges from about 1 cm to about 30 cm, while the second radius a₁ ranges from about 1 mm to about 40 mm. In some embodiments, the tapered tip 128 tapers from the first radius a₁ to the second radius a₂ at a tapering angle θₜₐₚₑᵣ ranging from about 40° to about 85°, with the tapering angle θₜₐₚₑᵣ being defined with respect to a direction parallel the pinch axis 118, as illustrated in FIG. 1. In some embodiments, the tapered tip 128 tapers linearly from the first radius a₁ to the second radius a₂, as in FIG. 1. In other embodiments, the tapered tip 128 tapers nonlinearly from the first radius a₁ to the second radius a₂, as depicted in FIG. 7. Returning to FIG. 1, in some embodiments, the tapered tip has a longitudinal extent ranging from about 1 cm to about 10 cm. In some embodiments, a ratio of the longitudinal extent of the tapered tip 128 to a longitudinal extent of the inner electrode 110 ranges from about 0.05 to about 0.7. More details are provided below regarding how the provision of the tapered tip 128 can increase the thermonuclear neutron yield of the plasma focus system 100.

The electrode assembly 102 of FIG. 1 also includes an electrode insulator 134 disposed between the inner electrode 110 and the outer electrode 112 at the discharge ends 120, 124 thereof. The electrode insulator 134 is configured to provide electrical insulation between the inner electrode 110 and the outer electrode 112. The electrode insulator 134 is also configured to provide a discharge surface on which the ionization and breakdown of the process gas 116 can be initiated. In FIG. 1, the electrode insulator 134 has an annular cross-sectional shape, but other shapes are possible in other embodiments. Depending on the application, the electrode insulator 134 may be formed of one piece or material or multiple pieces of material. The electrode insulator 134 may be made of any suitable electrically insulating material. Non-limiting examples of such possible materials include, to name a few, alumina, ceramics, and quartz. Depending on the application, the electrode insulator 134 may be of varying sizes, shapes, compositions, locations, and configurations.

Referring still to FIG. 1, the power supply unit 104 is electrically connected to the inner electrode 110 and the outer electrode 112 via appropriate electrical connections. The term “power supply” refers herein to any device or combination of devices configured to supply electrical power into a form usable by another device or combination of devices. In some embodiments, the power supply unit 104 can include a pulsed high-power source (e.g., a capacitor bank, a Marx generator, or a linear transformer driver) and a switch (e.g., a spark gap, an ignitron, or a semiconductor switch). Other suitable types of power supplies may be used in other embodiments. The power supply unit 104 is configured to apply a discharge driving signal to the inner electrode 110 and the outer electrodes 112, so as to create a discharge voltage across the plasma channel 114. In some embodiments, the discharge driving signal is a voltage pulse having a peak magnitude ranging from about 12 kV to about 1 MV, a half-cycle pulse duration ranging from about 1 μs to about 50 μs, and a peak current amplitude ranging from about 100 kA to about 10 MA, although other peak magnitude voltage values, other pulse duration values, and other peak current amplitudes may be used in other embodiments. It is appreciated that the instrumentation, implementation, and operation of power supplies used in plasma focus systems are generally known in the art and need not be described in greater detail herein.

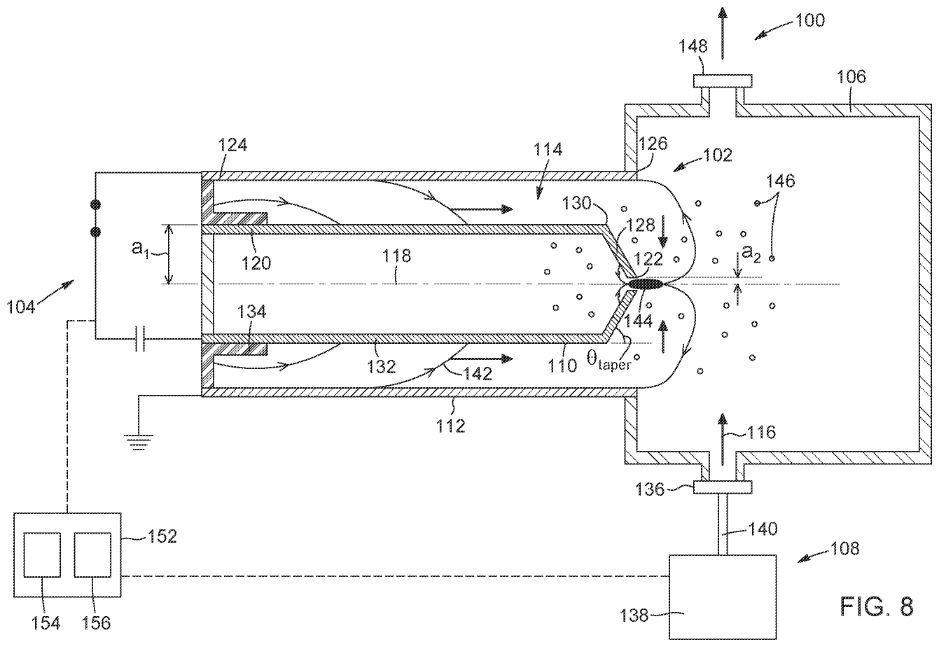

The vacuum chamber 106 is configured to house various components of the plasma focus system 100, including the plasma channel 114 defined in the annular gap formed between the inner electrode 110 and the outer electrode 112. The vacuum chamber 106 may be embodied by any suitable pressure vessel. In some embodiments, the vacuum chamber 106 may be provided as a cylindrical tank made of stainless steel and coaxially enclosing the electrode assembly 102. Various other configurations may be used in other embodiments. For example, in some embodiments, the outer electrode 112 may form part of the vacuum chamber 106, as depicted in the embodiment of FIG. 8. Returning to FIG. 1, the vacuum chamber 106 can include at least one gas inlet port 136 configured for connection to the process gas supply unit 108 to allow the process gas 116 to be introduced inside the vacuum chamber 106. The vacuum chamber 106 can also include various other ports, such as a vacuum pump port 148 and diagnostics ports (not shown). In some embodiments, the vacuum pump port 148 can be connected to a vacuum pump system (not shown) of sufficient capacity to achieve a base pressure lower than 1/100 of the lowest operational pressure when filled with the process gas 116. The vacuum chamber 106 may be connected to a pressure control unit (not shown) configured to control the fill pressure of the process gas 116 inside the vacuum chamber 106. In some embodiments, the fill pressure of the process gas 116 can range from about 1 Torr to about 100 Torr, although other ranges of fill pressure may be used in other embodiments.

The process gas 116 can be any suitable gas or gas mixture from which fusion neutrons can be produced via neutronic fusion reactions by the plasma focus system 100. In some embodiments, the process gas 116 may be deuterium gas (to produce D-D neutrons) or a gas mixture containing deuterium and tritium (to produce D-T neutrons), or another suitable neutronic fusion fuel.

The process gas supply unit 108 can include or be coupled to a gas source 138 configured to store the process gas 116. The gas source 138 can be embodied by a gas storage tank or any suitable pressurized dispensing container. The process gas supply unit 108 can also include a process gas supply line 140 connected between the gas source 138 and the gas inlet port 136 of the vacuum chamber 106 to allow the process gas 116 to enter and fill the interior of the vacuum chamber 106. The process gas supply unit 108 can also include various additional flow control devices (not shown), for example, valves, pumps, regulators, and restrictors configured to control the introduction of the process gas 116 inside the vacuum chamber 106. It is appreciated that various configurations and arrangements are contemplated for the process gas supply unit 108, and that various gas injection techniques can be used.

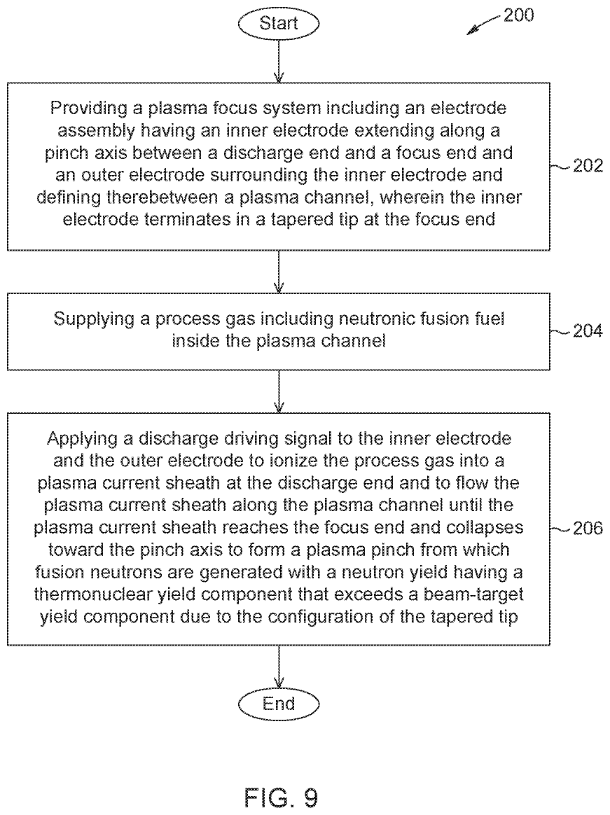

The operation of embodiments of the plasma focus system disclosed herein will now be considered in greater detail, with reference to the flow diagram of FIG. 9, which represents an embodiment of a plasma focus method 200 of neutron production. It is appreciated that the theory and operation of the various phases of plasma focus dynamics-including the breakdown phase, the axial acceleration phase, the radial compression phase and the pinch phase, as well as their various sub-pbases—are generally known in the art and need not be described in detail herein other than to facilitate an understanding of the present techniques (see, e.g., [2, 3]).

The method 200 can include a step 202 of providing a plasma focus system 100, such as the ones depicted in FIGS. 1 to 8, or another suitable plasma focus system. The plasma focus system 100 can include an electrode assembly 102 having an inner electrode 110 and an outer electrode 112. The inner electrode 110 extends along a pinch axis 118 between a discharge end 120 and a focus end 122 and terminates in a tapered tip 128 at the focus end 122. The outer electrode 112 surrounds the inner electrode 110 and defines therebetween a plasma channel 114. For example, the outer electrode 112 can enclose the inner electrode 110 in a coaxial arrangement with respect to the pinch axis 118.

The method 200 can also include a step 204 of supplying a process gas 116 containing neutronic fusion fuel inside the plasma channel 114 formed between the inner electrode 110 and the outer electrode 112. This step 204 can be performed by using a suitable process gas supply unit 108 to supply the process gas 116 into a vacuum chamber 106 housing at least part of the electrode assembly 102. As noted above, the neutronic fusion fuel can include deuterium or a mixture of deuterium and tritium. In some embodiments, the step 204 of supplying the process gas 116 inside the plasma channel 114 can be performed over a time period ranging from about 1 second to about 100 seconds.

The method 200 can further include a step 206 of applying the discharge driving signal to the inner electrode 110 and the outer electrode 112. This step 206 can be performed by using a suitable power supply unit 104 that is part of or coupled to plasma focus system 100. For example, the power supply unit 104 can be embodied by a pulsed-DC power supply including a capacitor bank and a switch. The application of the discharge driving signal causes the process gas 116 to be ionized and to form a plasma current sheath 142 inside the plasma channel 114, at the discharge ends 120, 124 of the electrodes 110, 112. The Lorentz force drives the plasma current sheath 142 down the plasma channel 114. Upon reaching the focus end 122 of the inner electrode 110, the plasma current sheath 142 radially collapses toward the pinch axis 118 to form a hot and dense plasma pinch 144. In some embodiments, the tapered tip 128 has a hollow interior, which can allow the plasma pinch 144 to extend at least partly inside the tapered tip 128. During the pinch phase, instabilities and turbulences within the plasma pinch 144 lead to the generation of fusion neutrons 146 with a neutron yield Yₙ having a beam-target yield component Y_{bt} and a thermonuclear yield component Yₜₕ, where Yₙ=Y_{bt}+Yₜₕ. The plasma pinch 144 can also emit electron and ion beams, as well as electromagnetic radiation (e.g., X-rays).

In some embodiments, the step 206 of applying the discharge driving signal (e.g., by discharging the capacitor bank of the power supply unit 104 into the electrode assembly 102) can be performed over a time period ranging from about 1 microsecond to about 1 millisecond. In some embodiments, the step 206 of applying the discharge driving signal can be initiated after a time delay ranging from about 1 millisecond to about 100 seconds after initiating the step 204 of supplying the process gas 116 inside the plasma channel 114. In some embodiments, the step 206 of applying the discharge driving signal can be repeated at longer intervals (e.g., the discharge driving signal is applied once every one minute to sixty minutes or longer, which can be referred to as a single-shot operation mode) or at shorter intervals (e.g., the discharge driving signal is applied once every ten milliseconds to ten seconds, which can be referred to as a repetitive-shot operation mode). In some embodiments, the processes going from the formation of the plasma current sheath to the generation of the fusion neutrons 146 can occur over a time period ranging from about 1 microsecond to about 10 microseconds.

In the plasma focus system 100 of FIG. 1, the tapered tip 128 of the inner electrode 110 is configured to increase the speed of the plasma current sheath 142 as it flows therealong sufficiently for the resulting plasma pinch 144 to reach a pinch temperature at which the thermonuclear yield component Yₜₕ of the produced neutrons exceeds the beam-target yield component Y_{bt}, as discussed in greater detail below. In some embodiments, the tapered tip 128 is configured to increase, during the radial phase, the maximum speed of the plasma current sheath 142 by a speed-enhancement factor ranging from about four to about thirty compared to the maximum sheath speed achievable without the provision of the tapered tip 128. For example, in some embodiments, the step 206 of applying the discharge driving signal can include controlling the discharge driving signal based on the configuration of the tapered tip 128 to control a speed of the plasma current sheath 142 to reach a maximum sheath speed value ranging from about 60 cm/μs to about 500 cm/μs as the plasma current sheath collapses toward the pinch axis to form the plasma pinch 144. Such sheath speed values during the radial phase are significantly higher than those achievable in conventional plasma focus systems, which can range from about 14 cm/μs to about 30 cm/μs.

In addition to increasing the speed of the plasma current sheath 142 in the radial phase just before formation of the plasma pinch 144, the provision of the tapered tip 128 can allow for the angular disparity due to the mass-field-force-field separation effect mentioned above to be controlled (e.g., avoided or at least mitigated). When the plasma current sheath 142 flows along the tapered tip 128, its speed gradually increases until the plasma current sheath 142 reaches the end of the tapered tip 128, which corresponds to the focus end 122 of the inner electrode 110. Then, the radial phase begins, which leads to the formation of the plasma pinch 144. With the provision of the tapered tip 128, the plasma current sheath 142 can move at a significantly higher speed during the radial phase than in conventional plasma focus systems. This enhanced sheath speed in the radial phase can be understood from the fact that the speed factor of the plasma current sheath 142, at any radius r, is S=(l/r)p^{-1/2}. This means that the ratio of the sheath speed at the exit of the tapered tip 128 to the sheath speed at the entrance of the tapered tip 128 is expected to scale as a₁/a₂. The step 206 of applying the discharge driving signal can include controlling the discharge driving signal to control a speed of the plasma current sheath 142 prior to the tapered tip to remain below a threshold sheath speed value at which the plasma current sheath 120 undergoes or is expected to undergo mass-field-force-field separation. For example, in some embodiments, the threshold sheath speed value can be about 10 cm/μs.

It is appreciated that by providing a sufficiently large tapering angle (e.g., larger than) 40°, the tapered tip 128 can have both a sufficiently large radius ratio a₁/a₂ to achieve thermonuclear conversion and a sufficiently short axial length to avoid or at least mitigate the angular disparity between the mass-field direction and the force-field direction due to the mass-field-force-field separation. It is also appreciated that in some embodiments, the plasma focus system 100 can be operated as would a conventional plasma focus system (e.g., operating with axial speeds of the order of 10 cm/μs), so that the increase in speed along the tapered tip 128 results from the provision of the tip 128 itself, without requiring additional changes in the operating parameters of the system 100 (e.g., in the operating parameters of the power supply unit 104 and/or the vacuum chamber 106).

In the plasma focus system 100 of FIG. 1, the plasma pinch 144 that is formed at the focus end 122 of the inner electrode 110 has a starting radial phase radius equal to a₂, which is smaller than the starting radial phase radius a₁ that would be obtained without the tapered tip 128. Thus, the compressing magnetic force acting on the plasma in the radial phase that forms the plasma pinch 144 is greater with the tapered tip 128 than without, resulting in greater implosion speed in the radial phase and in turn higher pinch temperature. As the pinch temperature T_{pinch} scales about quadratically with the speed factor S, the provision of the tapered tip 128 can increase the pinch temperature by a factor T_{pinch,taper}/T_{pinch,no-taper} that scales as (a₁/a₂)¹ (Iₜₐₚₑᵣ/Iₙₒ₋ₜₐₚₑᵣ)², where Iₜₐₚₑᵣ and Iₙₒ₋ₜₐₚₑᵣ are the peak drive currents with and without the tapered tip 128, respectively. Due to the already angled flow along the length of the tapered tip 128, there is only a small angle to turn into the radial phase so that the angular disparity due to any residual mass-field-force-field separation is reduced. It is noted that Iₜₐₚₑᵣ is generally less than Iₙₒ₋ₜₐₚₑᵣ due to the additional inductive effects of the increased speeds of the plasma current sheath 142 down the length of the tapered tip 128. For example, using a₁/a₂=15 and Iₜₐₚₑᵣ/Iₙₒ₋ₜₐₚₑᵣ=0.9 yields T_{pinch,taper}/T_{pinch,no-taper}≈200. According to this example, the provision of the tapered tip 128 at the focus end 122 of the inner electrode 110 can increase the pinch temperature from 0.1 keV, which is a pinch temperature observed in large conventional plasma focus systems, to 20 keV, which is a pinch temperature at which thermonuclear neutron yield is expected to be significant. In some embodiments, the step 206 of applying the discharge driving signal includes controlling the discharge driving signal based on the configuration of the tapered tip 128 to form the plasma pinch 144 with a pinch temperature T_{pinch} ranging from about 3 keV to about 200 keV.

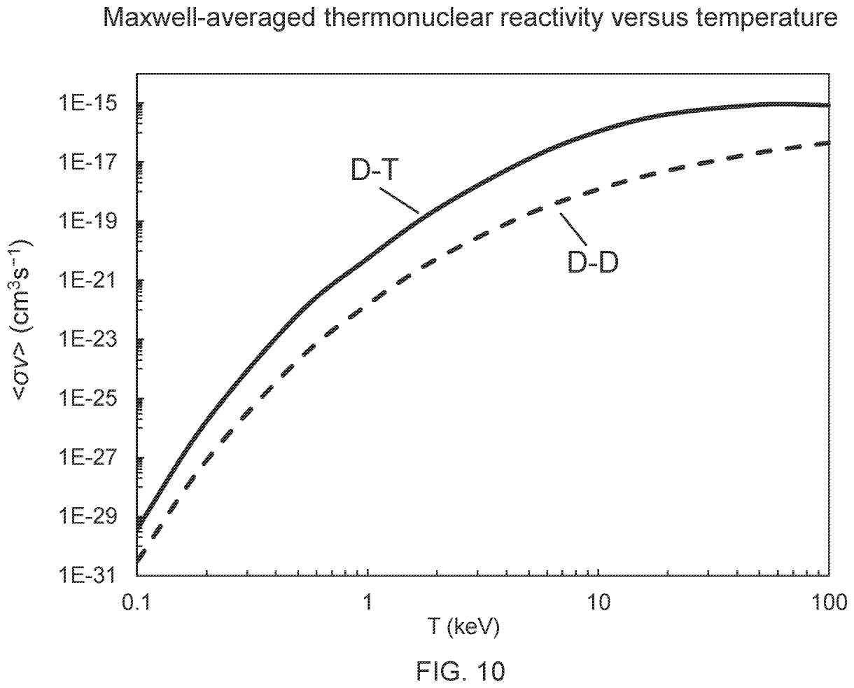

FIG. 10 depicts curves of the Maxwell-averaged thermonuclear fusion reactivity <σv> (in cm³ s⁻¹) plotted as functions of temperature T (in keV) on a log-log scale for the D-T and D-D reactions. The thermonuclear reactivity <σv> represents the fusion cross-section and relative velocity of two potential fusion reactants, averaged over the Maxwell-Boltzmann distribution. The thermonuclear reactivity <σv> characterizes the probability of a given thermonuclear fusion reaction (e.g., the D-T reaction) as a function of the kinetic temperature of the reactants. It is seen from FIG. 10 that the averaged reactivities <σv>_{D-T} and <σv>_{D-D} increase respectively by about 14 and 13 orders of magnitude between 0.1 keV and 20 keV.

In plasma focus systems, the thermonuclear neutron yield Yₜₕ scales as Yₜₕ˜ V_{pinch}τ_{pinch}<σv>, where V_{pinch} and τ_{pinch} are respectively the volume and lifetime of the plasma pinch, and where V_{pinch}˜a³ and τ_{pinch}˜a, with a being the radius of the inner electrode at its focus end [1]. For the example given above with T_{pinch,no-taper}=0.1 keV and T_{pinch,taper}=20 keV, one can find that the thermonuclear neutron yield is increased by a factor Y_{th,taper}/Y_{th,no-taper}˜<σv>/(a₁/a₂)⁴≈10¹⁴/15⁴≈10⁹ when operating with deuterium-tritium and by a factor Y_{th,taper}/Y_{th,no-taper}˜<σv>(a₁/a₂)≈10¹³/15⁴≈10⁸ when operating in deuterium. This scaling of the thermonuclear neutron yield Yₜₕ can be tested and verified using the Lee model code [3], a widely recognized and verified [2; pp. 510-513] code used for simulating the operation of plasma focus systems, including neutron yields.

Numerically computed example for a large 8-MJ plasma focus system. The Lee model code was used to compute the total, thermonuclear, and beam-target neutron yields (Yₙ, Yₜₕ, and Y_{bt}) for a conventional plasma focus system and an embodiment of a plasma focus system including an inner electrode terminating in a tapered tip. The following model parameters were used.

TABLE I
Model Parameters.

| | | Embodiment of |
|---|---|---|
| | Conventional plasma | plasma focus |
| | focus system without | system with |
| Model parameters | tapered tip | tapered tip |
| Charging voltage (MV) | 0.9 | 0.9 |
| Bank capacitance (μF) | 20 | 20 |
| Stored energy (MJ) | 8.1 | 8.1 |
| Outer electrode radius (cm) | 20 | 20 |
| Inner electrode radius (cm) | 15 | 15 (in the |
| | | straight section) |
| Inner electrode length (cm) | 5 | 5 |
| Damping resistance (mΩ) | 7 | 7 |
| Process gas | D-T (50:50) | D-T (50:50) |
| Fill pressure (Torr) | 100 | 100 |
| Axial phase mass factor | 0.08 | 0.08 |
| Axial phase current factor | 0.7 | 0.7 |
| Radial phase mass factor | 0.2 | 0.2 |
| Radial phase current factor | 0.7 | 0.7 |
| Taper start point from the | — | 3 |
| discharge end (cm) | | |
| Tapered tip radius at the | — | 1 |
| focus end (cm) | | |

The computation produced the following results, where the neutron yields are given in D-T neutrons per shot.

TABLE II
Computation Results.

| | | Embodiment of |
|---|---|---|
| | Conventional plasma | plasma focus |
| | focus system without | system with |
| Computed results | tapered tip | tapered tip |
| Thermonuclear neutron yield Yₜₕ | 1.8 × 10⁵ | 1.5 × 10¹⁵ |
| Beam-target neutron yield Y_{bt} | 1.2 × 10¹⁴ | 2 × 10¹¹ |
| Total neutron yield Yₙ = Yₜₕ + | 1.2 × 10¹⁴ | 1.5 × 10¹⁵ |
| Y_{bt} | | |
| Thermonuclear to beam-target | 1.5 × 10⁻⁹ | 7.5 × 10³ |
| yield | | |
| ratio Yₜₕ/Yₙ | | |

In this example, the provision of the tapered tip decreases the beam-target yield component Y_{bt} by a factor of about 103, but increases the thermonuclear yield component Yₜₕ by a factor of about 1010. By providing the tapered tip, neutron emission switches from a nearly 100 percent beam-target production mode (Y_{bt}<<Yₜₕ; Yₙ≈Y_{bt}) to a nearly 100 percent thermonuclear production mode (Yₜₕ>>Y_{bt}; Yₙ≈Yₜₕ), and the total neutron yield Yₙ is increased by about one order of magnitude. This example illustrates how a tapered tip having a suitable configuration can be used as both a thermonuclear converter and neutron yield enhancer.

Returning to FIG. 10, in some embodiments, the step 206 of applying the discharge driving signal includes controlling the discharge driving signal based on the configuration of the tapered tip to control a ratio of the thermonuclear yield component Yₙ to the beam-target yield component Y_{bt} to range from about 10 (i.e., Yₜₕ/Yₙ≈0.9) to about 100,000 (i.e., Yₜₕ/Yₙ≈1). In some embodiments, the step 206 of applying the discharge driving signal includes controlling the discharge driving signal based on the configuration of the tapered tip to control a ratio of the thermonuclear yield Yₜₕ component to the total neutron yield Yₙ to be larger than 0.5, or larger than 0.6, or larger than 0.7, or larger than 0.8, or larger than 0.9, or larger than 0.95, or larger than 0.99.

Returning to FIG. 9, it is appreciated that since the thermonuclear reactivities <σv>_{D-T} and <σv>_{D-D} vary exponentially as a function of temperature in the range from 0.1 keV to 100 keV, so does the yield ratio Yₜₕ/Yₙ as a function of the radius ratio a₁/a₂ of the tapered tip. This means that the thermonuclear conversion efficiency of the tapered tip can be quite sensitive to the value of the radius ratio a₁/a₂. For instance, in the example given above, using a tapered tip with a radius ratio a₁/a₂=15 instead of a non-tapered tip led to a switch from a nearly 100 percent beam-target production mode to a nearly 100 percent thermonuclear production mode. A comparable switch is also obtained for a tapered tip with a radius ratio a₁/a₂=8. However, using a tapered tip with a slightly smaller radius ratio, for example, a₁/a₂=4, would change the nearly 100 percent beam-target production mode only to a 70 percent thermonuclear production mode (Yₜₕ/Yₙ≈0.7), thus reducing the thermonuclear conversion efficiency of the tip. For further illustration, using a₁/a₂=2 would lead to Yₜₕ/Yₙ≈0.004. It has been recognized herein that due to the fact that the thermonuclear reactivity <σv> of several neutronic fusion reactions, including the D-D and D-T reactions, increases exponentially with increasing temperature in the range from 0.1 keV to 100 keV, which overlaps and extends appreciably beyond the pinch temperature range observed in conventional plasma focus systems, a radius ratio of at least about one order of magnitude (e.g., equal to or larger than about eight to twelve) is desirable or required in some embodiments for the tapered tip to operate as an efficient thermonuclear converter.

Returning to FIG. 1, the plasma focus system 100 can further include a control and processing unit 152 configured to control, monitor, and/or coordinate the functions and operations of various system components, including the power supply unit 104, the vacuum chamber 106, and the process gas supply unit 108, as well as various temperature, pressure, flow rate, and power conditions. In particular, the control and processing unit 152 may be configured to synchronize or otherwise time-coordinate the functions and operations of various components of the plasma focus system 100. The control and processing unit 152 can be implemented in hardware, software, firmware, or any combination thereof, and be connected to various components of the plasma focus system 100 via wired and/or wireless communication links to send and/or receive various types of signals, such as timing and control signals, measurement signals, and data signals. The control and processing unit 152 may be controlled by direct user input and/or by programmed instructions, and may include an operating system for controlling and managing various functions of the plasma focus system 100. Depending on the application, the control and processing unit 152 may be fully or partly integrated with, or physically separate from, the other hardware components of the plasma focus system 100. The control and processing unit 152 can include a processor 154 and a memory 156.

The processor 154 can implement operating systems, and may be able to execute computer programs, also known as commands, instructions, functions, processes, software codes, executables, applications, and the like. While the processor 154 is depicted in FIG. 1 as a single entity for illustrative purposes, the term “processor” should not be construed as being limited to a single processing entity, and accordingly, any known processor architecture may be used. In some embodiments, the processor 154 may include a plurality of processing entities. Such processing entities may be physically located within the same device, or the processor 154 may represent the processing functionalities of a plurality of devices operating in coordination. For example, the processor 154 may include or be part of one or more of a computer; a microprocessor; a microcontroller; a coprocessor; a central processing unit (CPU); a special-purpose programmable logic device embodied in hardware device, such as, for example, a field-programmable gate array (FPGA) or an application-specific integrated circuit (ASIC); a digital processor; an analog processor; and/or other mechanisms configured to electronically process information and to operate collectively as a processor.

The memory 156, which may also be referred to as a “computer readable storage medium” or a “computer readable memory” is configured to store computer programs and other data to be retrieved by the processor 154. The terms “computer readable storage medium” and “computer readable memory” refer herein to a non-transitory and tangible computer product that can store and communicate executable instructions for the implementation of various steps of the techniques disclosed herein. The memory 156 may be any computer data storage device or assembly of such devices, including a random-access memory (RAM); a dynamic RAM; a read-only memory (ROM); a magnetic storage device; an optical storage device; a flash drive memory; and/or any other non-transitory memory technologies. The memory 156 may be associated with, coupled to, or included in the processor 154, and the processor 154 may be configured to execute instructions contained in a computer program stored in the memory 156 and relating to various functions and operations associated with the processor 154. While the memory 156 is depicted in FIG. 1 as a single entity for illustrative purposes, the term “memory” should not be construed as being limited to a single memory unit, and accordingly, any known memory architecture may be used. In some embodiments, the memory 156 may include a plurality of memory units. Such memory units may be physically located within the same device, or the memory 156 can represent the functionalities of a plurality of devices operating in coordination.

The plasma focus system 100 may also include one or more user interface devices (not shown) operatively connected to the control and processing unit 152 to allow the input of commands and queries to the plasma focus system 100, as well as present the outcomes of the commands and queries. The user interface devices can include input devices (e.g., a touch screen, a keypad, a keyboard, a mouse, a switch, and the like) and output devices (e.g., a display screen, a printer, visual and audible indicators and alerts, and the like).

The following aspects are also disclosed herein.
1. A plasma focus system for neutron production, comprising:
   an electrode assembly comprising:
      an inner electrode extending along a pinch axis between a discharge end and a focus end, the inner electrode terminating in a tapered tip at the focus end; and
      an outer electrode surrounding the inner electrode and defining therebetween a plasma channel configured to receive a process gas comprising neutronic fusion fuel; and
   a power supply unit configured to apply a discharge driving signal to the inner electrode and the outer electrode, wherein applying the discharge driving signal causes the process gas to be ionized into a plasma current sheath at the discharge end and the plasma current sheath to flow along the plasma channel and reach the focus end where the plasma current sheath collapses toward the pinch axis to form a plasma pinch from which fusion neutrons are generated with a neutron yield having a beam-target yield component and a thermonuclear yield component, and wherein the tapered tip is configured to increase a speed of the plasma current sheath flowing therealong sufficiently for the plasma pinch to reach a pinch temperature at which the thermonuclear yield component exceeds the beam-target yield component.
2. The plasma focus system of aspect 1, wherein the tapered tip tapers from a first radius, at a taper start point located between the discharge end and the focus end, to a second radius, at the focus end, wherein a ratio of the first radius to the second radius ranges from about eight to about fifty.
3. The plasma focus system of aspect 2, wherein the first radius ranges from about 1 cm to about 30 cm and the second radius ranges from about 1 mm to about 40 mm.
4. The plasma focus system of aspect 2 or 3, wherein the tapered tip tapers from the first radius to the second radius at a tapering angle ranging from about 40° to about 85°, wherein the tapering angle is defined with respect to a direction parallel to the pinch axis.
5. The plasma focus system of any one of aspects 2 to 4, wherein the tapered tip tapers linearly from the first radius to the second radius.
6. The plasma focus system of any one of aspects 2 to 4, wherein the tapered tip tapers nonlinearly from the first radius to the second radius.
7. The plasma focus system of any one of aspects 1 to 6, wherein the tapered tip has a longitudinal extent ranging from about 1 cm to about 10 cm.
8. The plasma focus system of aspect 7, wherein a ratio of the longitudinal extent of the tapered tip to a longitudinal extent of the inner electrode ranges from about 0.05 to about 0.7.
9. The plasma focus system of any one of aspects 1 to 8, wherein a ratio of a longitudinal extent of the inner electrode to a diameter of the inner electrode at the discharge end is greater than one.
10. The plasma focus system of any one of aspects 1 to 8, wherein a ratio of a longitudinal extent of the inner electrode to a diameter of the inner electrode at the discharge end is equal to or less than one.
11. The plasma focus system of any one of aspects 1 to 10, wherein the tapered tip has a hollow interior configured to allow the plasma pinch to extend at least partially thereinside.
12. The plasma focus system of any one of aspects 1 to 11, wherein the power supply unit comprises a pulsed-DC power supply comprising a capacitor bank and a switch.
13. The plasma focus system of any one of aspects 1 to 12, wherein the power supply unit is configured to apply the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.
14. The plasma focus system of any one of aspects 1 to 13, wherein the power supply unit is configured to apply the discharge driving signal based on the configuration of the tapered tip to control the speed of the plasma current sheath to reach a maximum sheath speed value ranging from about 60 cm/μs to about 500 cm/μs as the plasma current sheath collapses toward the pinch axis to form the plasma pinch.
15. The plasma focus system of any one of aspects 1 to 14, wherein the power supply unit is configured to apply the discharge driving signal based on the configuration of the tapered tip to form the plasma pinch with a pinch temperature ranging from about 3 keV to about 200 keV.
16. The plasma focus system of any one of aspects 1 to 15, wherein the power supply unit is configured to apply the discharge driving signal to control the speed of the plasma current sheath prior to the tapered tip to remain below a threshold sheath speed value at which the plasma current sheath undergoes mass-field-force-field separation.
17. The plasma focus system of aspect 16, wherein the threshold sheath speed value is about 10 cm/μs.
18. The plasma focus system of any one of aspects 1 to 17, wherein the power supply unit is configured to apply the discharge driving signal based on the configuration of the tapered tip to control a ratio of the thermonuclear yield component to the beam-target yield component to range from about 10 to about 100,000.
19. The plasma focus system of any one of aspects 1 to 18, wherein the power supply unit is configured to apply the discharge driving signal based on the configuration of the tapered tip to control a ratio of the thermonuclear yield component to the total neutron yield to be larger than 0.7.
20. The plasma focus system of any one of aspects 1 to 18, wherein the power supply unit is configured to apply the discharge driving signal based on the configuration of the tapered tip to control a ratio of the thermonuclear yield component to the total neutron yield to be larger than 0.9.
21. The plasma focus system of any one of aspects 1 to 18, wherein the power supply unit is configured to apply the discharge driving signal based on the configuration of the tapered tip to control a ratio of the thermonuclear yield component to the total neutron yield to be larger than 0.99.
22. The plasma focus system of any one of aspects 1 to 21, wherein the electrode assembly comprises an electrical insulator interposed between the inner electrode and the outer electrode at the discharge end.
23. The plasma focus system of any one of aspects 1 to 22, further comprising a vacuum chamber housing at least part of the electrode assembly and configured to contain the process gas therein.
24. The plasma focus system of aspect 23, wherein the outer electrode forms part of the vacuum chamber.
25. The plasma focus system of any one of aspects 1 to 24, further comprising a process gas supply unit configured to supply the process gas inside the plasma channel.
26. The plasma focus system of any one of aspects 1 to 25, wherein the neutronic fusion fuel comprises deuterium or a mixture of deuterium and tritium.
27. A plasma focus method of neutron production, comprising:
   providing a plasma focus system comprising an electrode assembly having an inner electrode extending along a pinch axis between a discharge end and a focus end and an outer electrode surrounding the inner electrode and defining therebetween a plasma channel, wherein the inner electrode terminates in a tapered tip at the focus end;
   supplying a process gas comprising neutronic fusion fuel inside the plasma channel; and
   applying a discharge driving signal to the inner electrode and the outer electrode to ionize the process gas into a plasma current sheath at the discharge end and to flow the plasma current sheath along the plasma channel until the plasma current sheath reaches the focus end and collapses toward the pinch axis to form a plasma pinch from which fusion neutrons are generated with a neutron yield having a beam-target yield component and a thermonuclear yield component, wherein the tapered tip is configured to increase a speed of the plasma current sheath flowing therealong sufficiently for the plasma pinch to reach a pinch temperature at which the thermonuclear yield component exceeds the beam-target yield component.
28. The plasma focus method of aspect 27, wherein providing the plasma focus system comprises configuring the tapered tip to taper from a first radius, at a taper start point located between the discharge end and the focus end, to a second radius, at the focus end, wherein a ratio of the first radius to the second radius ranges from about eight to about fifty.
29. The plasma focus method of aspect 28, wherein the first radius ranges from about 1 cm to about 30 cm and the second radius ranges from about 1 mm to about 40 mm.
30. The plasma focus method of aspect 28 or 29, wherein configuring the tapered tip comprises providing the tapered tip with a tapering angle ranging from about 40° to about 85°, wherein the tapering angle is defined with respect to a direction parallel to the pinch axis.
31. The plasma focus method of any one of aspects 27 to 30, wherein configuring the tapered tip comprises providing the tapered tip with a longitudinal extent ranging from about 1 cm to about 10 cm.
32. The plasma focus method of any one of aspects 27 to 31, wherein applying the discharge driving signal comprises applying the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.
33. The plasma focus method of any one of aspects 27 to 32, wherein applying the discharge driving signal comprises applying the discharge driving signal once every one minute to sixty minutes, corresponding to a single-shot operation mode.
34. The plasma focus method of any one of aspects 27 to 32, wherein applying the discharge driving signal comprises applying the discharge driving signal once every ten milliseconds to ten seconds, corresponding to a repetitive-shot operation mode.
35. The plasma focus method of any one of aspects 27 to 34, wherein applying the discharge driving signal comprises controlling the discharge driving signal based on the configuration of the tapered tip to control the speed of the plasma current sheath to reach a maximum sheath speed value ranging from about 60 cm/μs to about 500 cm/μs as the plasma current sheath collapses toward the pinch axis to form the plasma pinch.
36. The plasma focus method of any one of aspects 27 to 35, wherein applying the discharge driving signal comprises controlling the discharge driving signal based on the configuration of the tapered tip to form the plasma pinch with a pinch temperature ranging from about 3 keV to about 200 keV.
37. The plasma focus method of any one of aspects 27 to 36, wherein applying the discharge driving signal comprises controlling the discharge driving signal to control the speed of the plasma current sheath prior to the tapered tip to remain below a threshold sheath speed value at which the plasma current sheath undergoes mass-field-force-field separation.
38. The plasma focus method of aspect 37, wherein the threshold sheath speed value is about 10 cm/μs.
39. The plasma focus method of any one of aspects 27 to 38, wherein applying the discharge driving signal comprises controlling the discharge driving signal based on the configuration of the tapered tip to control a ratio of the thermonuclear yield component to the beam-target yield component to range from about 10 to about 100,000.
40. The plasma focus method of any one of aspects 27 to 39, wherein applying the discharge driving signal comprises controlling the discharge driving signal based on the configuration of the tapered tip to control a ratio of the thermonuclear yield component to the total neutron yield to be larger than 0.7.
41. The plasma focus method of any one of aspects 27 to 39, wherein applying the discharge driving signal comprises controlling the discharge driving signal based on the configuration of the tapered tip to control a ratio of the thermonuclear yield component to the total neutron yield to be larger than 0.9.
42. The plasma focus method of any one of aspects 27 to 39, wherein applying the discharge driving signal comprises controlling the discharge driving signal based on the configuration of the tapered tip to control a ratio of the thermonuclear yield component to the total neutron yield to be larger than 0.99.
43. The plasma focus method of any one of aspects 27 to 42, wherein providing the plasma focus system comprises enclosing at least part of the electrode assembly in a vacuum chamber configured to contain the process gas therein.
44. The plasma focus method of any one of aspects 27 to 43, wherein the neutronic fusion fuel comprises deuterium or a mixture of deuterium and tritium.

Numerous modifications could be made to the embodiments described above without departing from the scope of the appended claims.

### REFERENCES

The following is a list of references, the entire contents of which are incorporated herein by reference.
1. S. Lee and A. Serban, “Dimensions and lifetime of the plasma focus pinch,” IEEE Transactions on Plasma Science, vol. 24, no. 3, pp. 1101-1105 (1996).
2. S. Auluck, et al. “Update on the Scientific Status of the Plasma Focus,” Plasma, vol. 4, no. 3, pp. 450-669 (2021).
3. S. Lee, “Description of Radiative Dense Plasma Focus Computation Package RADPFV5.16 and Downloads—Lee model code”: http://www.plasmafocus.net/IPFS/modelpackage/FileIR.ADPF.htm

1. A plasma focus system for neutron production, comprising:
an electrode assembly comprising:
an inner electrode extending along a pinch axis between a discharge end and a focus end, the inner electrode terminating in a tapered tip at the focus end; and
an outer electrode surrounding the inner electrode and defining therebetween a plasma channel configured to receive a process gas comprising neutronic fusion fuel; and
a power supply unit configured to apply a discharge driving signal to the inner electrode and the outer electrode, wherein applying the discharge driving signal causes the process gas to be ionized into a plasma current sheath at the discharge end and the plasma current sheath to flow along the plasma channel and reach the focus end where the plasma current sheath collapses toward the pinch axis to form a plasma pinch from which fusion neutrons are generated with a neutron yield having a beam-target yield component and a thermonuclear yield component, and wherein the tapered tip is configured to increase a speed of the plasma current sheath flowing therealong sufficiently for the plasma pinch to reach a pinch temperature at which the thermonuclear yield component exceeds the beam-target yield component.

2. The plasma focus system of claim 1, wherein the tapered tip tapers from a first radius, at a taper start point located between the discharge end and the focus end, to a second radius, at the focus end, wherein a ratio of the first radius to the second radius ranges from about eight to about fifty.

3. The plasma focus system of claim 2, wherein the first radius ranges from about 1 cm to about 30 cm and the second radius ranges from about 1 mm to about 40 mm.

4. The plasma focus system of claim 2, wherein the tapered tip tapers from the first radius to the second radius at a tapering angle ranging from about 40° to about 85°, wherein the tapering angle is defined with respect to a direction parallel to the pinch axis.

5. The plasma focus system of claim 2, wherein the tapered tip tapers linearly from the first radius to the second radius.

6. The plasma focus system of claim 2, wherein the tapered tip tapers nonlinearly from the first radius to the second radius.

7. The plasma focus system of claim 1, wherein the tapered tip has a longitudinal extent ranging from about 1 cm to about 10 cm.

8. The plasma focus system of claim 7, wherein a ratio of the longitudinal extent of the tapered tip to a longitudinal extent of the inner electrode ranges from about 0.05 to about 0.7.

9. The plasma focus system of claim 1, wherein a ratio of a longitudinal extent of the inner electrode to a diameter of the inner electrode at the discharge end is greater than one.

10. The plasma focus system of claim 1, wherein a ratio of a longitudinal extent of the inner electrode to a diameter of the inner electrode at the discharge end is equal to or less than one.

11. The plasma focus system of claim 1, wherein the tapered tip has a hollow interior configured to allow the plasma pinch to extend at least partially thereinside.

12. The plasma focus system of claim 1, wherein the power supply unit comprises a pulsed-DC power supply comprising a capacitor bank and a switch.

13. The plasma focus system of claim 1, wherein the power supply unit is configured to apply the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.

14. The plasma focus system of claim 1, wherein the power supply unit is configured to apply the discharge driving signal based on the configuration of the tapered tip to control the speed of the plasma current sheath to reach a maximum sheath speed value ranging from about 60 cm/μs to about 500 cm/μs as the plasma current sheath collapses toward the pinch axis to form the plasma pinch.

15. The plasma focus system of claim 1, wherein the power supply unit is configured to apply the discharge driving signal based on the configuration of the tapered tip to form the plasma pinch with a pinch temperature ranging from about 3 keV to about 200 keV.

16. The plasma focus system of claim 1, wherein the power supply unit is configured to apply the discharge driving signal to control the speed of the plasma current sheath prior to the tapered tip to remain below a threshold sheath speed value at which the plasma current sheath undergoes mass-field-force-field separation.

17. The plasma focus system of claim 16, wherein the threshold sheath speed value is about 10 cm/μs.

18. The plasma focus system of claim 1, wherein the power supply unit is configured to apply the discharge driving signal based on the configuration of the tapered tip to control a ratio of the thermonuclear yield component to the beam-target yield component to range from about 10 to about 100,000.

19. The plasma focus system of claim 1, wherein the power supply unit is configured to apply the discharge driving signal based on the configuration of the tapered tip to control a ratio of the thermonuclear yield component to the total neutron yield to be larger than 0.7.

20. The plasma focus system of claim 1, wherein the power supply unit is configured to apply the discharge driving signal based on the configuration of the tapered tip to control a ratio of the thermonuclear yield component to the total neutron yield to be larger than 0.9.

21. The plasma focus system of claim 1, wherein the power supply unit is configured to apply the discharge driving signal based on the configuration of the tapered tip to control a ratio of the thermonuclear yield component to the total neutron yield to be larger than 0.99.

22. The plasma focus system of claim 1, wherein the electrode assembly comprises an electrical insulator interposed between the inner electrode and the outer electrode at the discharge end.

23. The plasma focus system of claim 1, further comprising a vacuum chamber housing at least part of the electrode assembly and configured to contain the process gas therein.

24. The plasma focus system of claim 23, wherein the outer electrode forms part of the vacuum chamber.

25. The plasma focus system of claim 1, further comprising a process gas supply unit configured to supply the process gas inside the plasma channel.

26. The plasma focus system of claim 1, wherein the neutronic fusion fuel comprises deuterium or a mixture of deuterium and tritium.

27. A plasma focus method of neutron production, comprising:
providing a plasma focus system comprising an electrode assembly having an inner electrode extending along a pinch axis between a discharge end and a focus end and an outer electrode surrounding the inner electrode and defining therebetween a plasma channel, wherein the inner electrode terminates in a tapered tip at the focus end;
supplying a process gas comprising neutronic fusion fuel inside the plasma channel; and
applying a discharge driving signal to the inner electrode and the outer electrode to ionize the process gas into a plasma current sheath at the discharge end and to flow the plasma current sheath along the plasma channel until the plasma current sheath reaches the focus end and collapses toward the pinch axis to form a plasma pinch from which fusion neutrons are generated with a neutron yield having a beam-target yield component and a thermonuclear yield component,
wherein the tapered tip is configured to increase a speed of the plasma current sheath flowing therealong sufficiently for the plasma pinch to reach a pinch temperature at which the thermonuclear yield component exceeds the beam-target yield component.

28. The plasma focus method of claim 27, wherein providing the plasma focus system comprises configuring the tapered tip to taper from a first radius, at a taper start point located between the discharge end and the focus end, to a second radius, at the focus end, wherein a ratio of the first radius to the second radius ranges from about eight to about fifty.

29. The plasma focus method of claim 28, wherein the first radius ranges from about 1 cm to about 30 cm and the second radius ranges from about 1 mm to about 40 mm.

30. The plasma focus method of claim 28, wherein configuring the tapered tip comprises providing the tapered tip with a tapering angle ranging from about 40° to about 85°, wherein the tapering angle is defined with respect to a direction parallel to the pinch axis.

31. The plasma focus method of claim 27, wherein configuring the tapered tip comprises providing the tapered tip with a longitudinal extent ranging from about 1 cm to about 10 cm.

32. The plasma focus method of claim 27, wherein applying the discharge driving signal comprises applying the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.

33. The plasma focus method of claim 27, wherein applying the discharge driving signal comprises applying the discharge driving signal once every one minute to sixty minutes, corresponding to a single-shot operation mode.

34. The plasma focus method of claim 27, wherein applying the discharge driving signal comprises applying the discharge driving signal once every ten milliseconds to ten seconds, corresponding to a repetitive-shot operation mode.

35. The plasma focus method of claim 27, wherein applying the discharge driving signal comprises controlling the discharge driving signal based on the configuration of the tapered tip to control the speed of the plasma current sheath to reach a maximum sheath speed value ranging from about 60 cm/μs to about 500 cm/μs as the plasma current sheath collapses toward the pinch axis to form the plasma pinch.

36. The plasma focus method of claim 27, wherein applying the discharge driving signal comprises controlling the discharge driving signal based on the configuration of the tapered tip to form the plasma pinch with a pinch temperature ranging from about 3 keV to about 200 keV.

37. The plasma focus method of claim 27, wherein applying the discharge driving signal comprises controlling the discharge driving signal to control the speed of the plasma current sheath prior to the tapered tip to remain below a threshold sheath speed value at which the plasma current sheath undergoes mass-field-force-field separation.

38. The plasma focus method of claim 37, wherein the threshold sheath speed value is about 10 cm/μs.

39. The plasma focus method of claim 27, wherein applying the discharge driving signal comprises controlling the discharge driving signal based on the configuration of the tapered tip to control a ratio of the thermonuclear yield component to the beam-target yield component to range from about 10 to about 100,000.

40. The plasma focus method of claim 27, wherein applying the discharge driving signal comprises controlling the discharge driving signal based on the configuration of the tapered tip to control a ratio of the thermonuclear yield component to the total neutron yield to be larger than 0.7.

41. The plasma focus method of claim 27, wherein applying the discharge driving signal comprises controlling the discharge driving signal based on the configuration of the tapered tip to control a ratio of the thermonuclear yield component to the total neutron yield to be larger than 0.9.

42. The plasma focus method of claim 27, wherein applying the discharge driving signal comprises controlling the discharge driving signal based on the configuration of the tapered tip to control a ratio of the thermonuclear yield component to the total neutron yield to be larger than 0.99.

43. The plasma focus method of claim 27, wherein providing the plasma focus system comprises enclosing at least part of the electrode assembly in a vacuum chamber configured to contain the process gas therein.

44. The plasma focus method of claim 27, wherein the neutronic fusion fuel comprises deuterium or a mixture of deuterium and tritium.
